(19) United States
(12) Patent Application Publication
(10) Pub. No.: US 2025/0264117 A1
(43) Pub. Date: Aug. 21, 2025

(54) Hydraulic Drive System

(71) Applicant: HMS--Hybrid Motion Solutions GmbH, Rutesheim (DE)

(72) Inventors: Achim HELBIG, Stuttgart (DE); Mattias ROEGNER, Erlingheim (DE); Dirk BECHER, Nufringen (DE); Tino KENTSCHKE, Weil der Stsdt (DE)

(21) Appl. No.: 18/563,409

(22) PCT Filed: Apr. 28, 2022
(86) PCT No.: PCT/EP2022/061355

§ 371 Date: May 27, 2024

(30) Foreign Application Priority Data
May 27, 2021 (DE) 10 2021 113 665.2

(51) Int. Cl. F15B 7/00; F15B 1/26; F15B 19/00

(52) U.S. Cl. CPC F15B 7/001; F15B 1/265; F15B 7/006; F15B 19/002; F15B 2211/20515; F15B 2211/20538; F15B 2211/20576; F15B 2211/2658

(57) ABSTRACT

The invention relates to a hydraulic drive system, to a method for adjusting a delivery volume in a hydraulic drive system, and to the use of the hydraulic drive system for controlling a hydraulic cylinder. The hydraulic drive system according to the invention is a hydraulic drive system with a first hydraulic machine and a second hydraulic machine which are connected mechanically to one another. The first hydraulic machine and the second hydraulic machine are operated jointly by a variable-speed drive. The first hydraulic machine and the second hydraulic machine are connected hydraulically to at least one first hydraulic cylinder, comprising a first hydraulic cylinder surface and a second hydraulic cylinder surface. The first hydraulic machine and/or the second hydraulic machine have/has an adjustable delivery volume.

The invention relates to a hydraulic drive system, a method for adjusting a delivery volume in a hydraulic drive system and the use of the hydraulic drive system for controlling a hydraulic cylinder.

Hydraulic drive systems are used in many types of industrial applications. For example, standardised hydraulic drive systems can be found in forming technology systems such as presses, rolling mills and generally in the construction of hydraulic units.

The publication DE 10 2010 020 690 A1 describes a drive system with two drive units. mechanically coupled hydraulic machines. These are driven by a primary drive. In the hydraulic drive system shown, two hydraulic machines are jointly driven at variable speed by a motor via a drive shaft. The motor is designed as an electric motor. Said electric motor can be driven with a variable speed and direction of rotation.

[symbol] can be operated. The two hydraulic machines of said hydraulic drive system are each fluid-hydraulically connected via a hydraulic connection to a respective side of the hydraulic cylinder and thus to the corresponding hydraulic cylinder surface, as well as to a reservoir. The two hydraulic machines can be arranged on the drive shaft in such a way that one of the two hydraulic machines

[symbol]

The first hydraulic machine represents the function of a pump and the other hydraulic machine acts as a motor. So

[symbol]

For example, the first hydraulic machine can provide the functionality of a pump for a clockwise direction of rotation and the second hydraulic machine acts as a motor. By changing the direction of rotation of the hydraulic machine so that it is driven in an anti-clockwise direction, the first hydraulic machine takes over the function of a pump. [symbol] functionality of a motor and the second hydraulic machine acts as a pump.

The problem with the solution described in DE 10 2010 020 690 A1 is that the delivery or intake volume of the two mechanically coupled hydraulic machines must be precisely matched to the cylinder area ratio.

This results in very limited utilisation options, as neither the hydraulic machines with a defined delivery or displacement volume nor the cylinder rods or piston rod diameter can be varied as required. The cylinder area ratio is generally determined by the drive task and its framework conditions. Hydraulic machines are available with a fixed graduated delivery or displacement volume. If the delivery volume of the two hydraulic machines is not precisely matched to the cylinder area ratio, this results in an increase in total pressure over the cylinder stroke. This increase in pressure leads to a lower effective force of the cylinder, as the cylinder chamber pressure level cannot be adjusted at will. high. Furthermore, the fixed connection of one hydraulic machine

[symbol]

The fact that one hydraulic machine has twice the displacement volume of the other when using a differential cylinder with an exemplary area ratio of 2:1 means that one hydraulic machine must be correspondingly large. This has an impact on the space requirement and the costs of the drive system.

Furthermore, a hydraulic drive system with a hydraulic machine in radial piston design with a control journal is known from publication EP 292 1700 A1. The hydraulic machine is driven at variable speed by a motor. The hydraulic machine has at least three hydraulic connections, whereby the

[symbol]

The delivery volume of the hydraulic connections is determined by the control spigot. The delivery volume is the volume of hydraulic fluid that flows through the cross-section of a component per revolution of the motor. A solution to the differential cylinder adjustment is solved in this publication via the aforementioned control journal of the hydraulic machine. The method described in the publication EP 292 1700 A1 solution, the problem arises that the control pin must be positioned exactly at the cylinder area ratio must be adjusted. As a result, the total pressure varies depending on the cylinder stroke.

DE 10 2011 056 894 A1 shows a drive with a differential cylinder whose inputs are connected to the outputs of a hydraulic differential transformer. A

[symbol]

The output of a pressure relief valve is connected to a reservoir for hydraulic oil. An input of a feed pump is connected to the reservoir. The

[symbol]

Feed pump pumps the hydraulic oil to a low-pressure side, and the pressure relief valve allows hydraulic oil to flow into the reservoir if a specified maximum pressure is exceeded on the low-pressure side.

DE 10 2013 008047 A1 shows a linear actuator with a double pump and with a [symbol] Differential cylinder whose annular chamber or piston rod chamber is bounded by an annular surface or piston rod surface of a piston and is connected to a first pump, and whose piston crown chamber is bounded by a piston crown surface of the piston and is connected to a second pump. Both pumps are driven by a common variable-speed electric motor. The ratio of the ring area to the piston crown area is equal to the ratio of the delivery volume of the first pump to the delivery volume of the second pump.

JP 2002 039110 A describes the operation of a single-sided rod cylinder at the same speed on an expansion side and a contraction side by a hybrid system driving a pump by an electric motor, and simplifying the operation of the cylinder to the same speed on an expansion side and a contraction side.

Circuit configuration. The cylinder is operated at the same speed on the expansion side and the contraction side by supplying and discharging oil into both the head-side and rod-side oil chambers of the hydraulic cylinder with a single-sided piston rod at a flow ratio corresponding to the cross-sectional area ratio of the two side oil chambers, both at the head-side and rod-side oil chambers.

[symbol] by a first hydraulic pump and a second hydraulic pump, which are driven by the electric motor.

EP 2 857 696 A1 shows a closed hydraulic circuit system with hydraulic pumps that maintains a balanced flow rate by automatically controlling the flow rate, even if an imbalance of a flow rate occurs during the operation.

[symbol] of the extension/retraction of a hydraulic cylinder device is caused by a pump capacity error. In this system, a first hydraulic pump is connected to the hydraulic cylinder device so as to form a closed hydraulic circuit, a second hydraulic pump is connected to an underside of the hydraulic cylinder device at one of the paired delivery ports and to a tank at the other of the ports, and a second hydraulic pump is connected to the hydraulic cylinder device at the other of the ports so as to form a closed hydraulic circuit.

[symbol] and a prime mover drives the first and second hydraulic pumps, and recovers driving force from these pumps. A pump capacity control unit detects a direction of movement of the hydraulic cylinder device and a pressure in a negative pressure side of the device and controls a capacity of the second hydraulic pump so that the flow rate during extension/retraction of the second hydraulic pump is controlled.

[symbol] hydraulic cylinder device between the first and second hydraulic pumps and the hydraulic cylinder device.

WO 2020/105560 A1 shows a hydraulic system comprising: a cylinder that moves a movable body in the vertical direction by utilising the expansion and contraction of a rod; a first bidirectional pump connected to a head-side pumping unit; and a second bidirectional pump connected to a head-side pumping unit.

[symbol] chamber in the cylinder through a first supply/discharge line; a second bidirectional pump connected to a rod-side chamber in the cylinder through a second supply/discharge line and coupled to the first bidirectional pump so as to be capable of transmitting torque; a relay line connecting the first bidirectional pump and the second bidirectional pump so that the first bidirectional pump and the second bidirectional pump are capable of transmitting torque; and a second bidirectional pump connected to a rod-side chamber in the cylinder through a second supply/discharge line and coupled to the first bidirectional pump so as to be capable of transmitting torque.

[symbol] hydraulic fluid discharged from either the first bidirectional pump or the second bidirectional pump is directed to the other pump; and a servomotor that drives either the first bidirectional pump or the second bidirectional pump. At least one of the first bidirectional pump and the second bidirectional pump is a variable-capacity pump capable of delivering the first bidirectional pump or the second bidirectional pump to the other pump.

Conveying capacity per revolution can be changed as required.

Variable displacement pumps are also known in the prior art. In hydraulic drive systems, a hydraulic cylinder is operated by at least two hydraulic machines, whereby at least one hydraulic machine is a variable displacement pump. In a variable displacement pump, the displacement of the stroke ring and thus the vanes of the variable displacement pump are moved via a hydraulic cylinder. This cylinder must be pressurised and hydraulic fluid, which means that a proportional valve is required to control the cylinder. This results in high structural and design-related costs. Furthermore, a control system is required for this cylinder, which leads to an increased energy problem, since a constant pressure system is required to supply this proportional valve. Therefore a variable displacement pump is inefficient and correspondingly complicated in terms of its design and its supply and is susceptible to maintenance and reduced reliability due to the other components and is cost-intensive to purchase, maintain and repair.

When operating a hydraulic cylinder, the total pressure in the hydraulic system should remain constant in order to maximise the effective force available. If the hydraulic cylinder is operated by a hydraulic drive system that only has one motor, the volume flow that is applied to the two motors must remain constant.

[symbol] hydraulic cylinder sides must be adapted precisely to the ratio of the two hydraulic cylinder sides. For example, if a differential cylinder with an area ratio of 2:1 is operated by a hydraulic drive system, the ratio of the delivery volume at the hydraulic connections of the two hydraulic cylinder sides must also be 2:1.

The problem that arises from this for the hydraulic drive systems known in the state of the art is that the delivery volumes of the hydraulic connections of the hydraulic machine(s), which are connected to the hydraulic cylinder sides, must be adapted to the hydraulic cylinder. This is done in the state of the art by selecting the two hydraulic machines or the control trunnion. The hydraulic machines have a non-variable delivery volume here. The delivery volume provided by the control spigot is also not variable. If the hydraulic drive system is now connected to a hydraulic cylinder that does not have the volume ratio that the hydraulic drive system is designed for.

[symbol] at least one of the hydraulic machines or the control trunnion must be replaced. This is associated with considerable labour and costs, as at least one of the two hydraulic machines must be replaced and a third hydraulic machine, which has a different delivery volume than the hydraulic machine to be replaced, must be installed instead.

Alternatively, the control spigot can be removed and replaced by a control spigot that has a different The control spigot must be replaced if it has a higher delivery volume than the previously used control spigot. This entire process is not only time-consuming and cost-intensive, but also prone to errors, which can lead to downtime and rework down the line.

One of the technical tasks underlying the invention can therefore be to at least partially eliminate the disadvantages recognised in the prior art and to provide a hydraulic drive system in which the delivery volume of the hydraulic machine(s) can be adapted to a hydraulic cylinder.

According to the invention, this task is solved in accordance with a first aspect by a hydraulic drive system with the features of independent patent claim 1. Advantageous further embodiments of the hydraulic drive system are shown in the subclaims relating to the hydraulic drive system.

According to the invention, the hydraulic drive system has a first hydraulic machine and a second hydraulic machine. The first hydraulic machine and the second hydraulic machine are mechanically connected to each other. For example, the first hydraulic machine and the second hydraulic machine can be mechanically connected to each other via a drive shaft. The first hydraulic machine or the second

[symbol]

Hydraulic machines are hydraulic machines with an adjustable stroke volume.

Furthermore, the first hydraulic motor and the second hydraulic motor are operated jointly by a variable-speed drive. The variable-speed drive can be designed as a variable-speed or variable-direction electric motor. Essentially, variable-speed drives consist of an electric motor, a hydraulic pump and a frequency converter whose software continuously adjusts the motor speed for the optimum operating point depending on the load. For example, an electrically driven fixed displacement pump supplies a demand-orientated volume flow to regulate pressure, speed, power, position or force depending on the task.

It is also provided that the first hydraulic machine and the second hydraulic machine are hydraulically connected to at least one first hydraulic cylinder. The hydraulic cylinder preferably has a first hydraulic cylinder surface and a second hydraulic cylinder surface. The hydraulic cylinder is preferably designed as a differential cylinder.

Alternatively, the hydraulic cylinder can be designed as a synchronised cylinders. The first hydraulic cylinder side and the second

[symbol]

The hydraulic cylinder side of the hydraulic cylinder can be designed both as the ring side and as the piston side of the hydraulic cylinder.

According to the present invention, the first hydraulic machine or the second hydraulic machine have an adjustable delivery volume.

For the purposes of the present invention, an adjustment means a manual mechanical stroke adjustment. The manual mechanical stroke adjustment can be used to determine the delivery volume per pump revolution. In the case of piston pumps and vane pumps in particular, the stroke of the pistons or vanes can be set manually by means of this adjustment. This

[symbol]

Stroke adjustment leads to a change in the delivery volume per revolution. It is

[symbol]

Furthermore, the delivery volume can be mechanically adjusted.

The selected stroke setting can be locked by means of a mechanical locking device. If the stroke is set using an adjusting spindle, it can be locked using a lock nut.

The delivery volume at the hydraulic connection of the first hydraulic cylinder side and the delivery volume at the hydraulic connection of the second hydraulic cylinder side can thus be adapted to the volume ratio of the first hydraulic cylinder side and the second hydraulic cylinder side.

In an advantageous way, an ideal adjustment of the delivery volume to the cylinder area ratio. An increase in total pressure over the cylinder stroke and thus a reduction in the effective force can be avoided. Another advantage is that the delivery volume only needs to be mechanically adjusted once in accordance with a first adjustment parameter. No permanent adjustment is required.

In particular, the present invention provides a reliable and energy-efficient efficient hydraulic drive system by preventing the system pressure increase, especially in differential cylinders.

In an advantageous embodiment, a ratio of the delivery volumes of the first hydraulic machine and the second hydraulic machine can be mechanically adjusted to an area ratio of the first hydraulic cylinder surface and the second hydraulic cylinder surface.

The ratio of the delivery volume of the first hydraulic machine to the delivery volume of the second hydraulic machine should correspond to the area ratio of the two hydraulic cylinder sides. The volume flow Q in the hydraulic drive system is determined by the variable speed of the first and second hydraulic cylinders.

The hydraulic machine is provided by the hydraulic motor and the delivery volume is adjusted via the adjustment parameter.

In a further advantageous embodiment, a delivery volume (volume V=dQ/dt of the hydraulic drive system is controlled by a specific adjustment parameter. For the purposes of the invention, the delivery volume corresponds to the volume of the hydraulic fluid which is moved per unit of time in the hydraulic drive system. The adjustment parameter can be determined, for example, using a method according to the further aspect of the present invention. In particular, the determined adjustment parameter (specific) is obtained with reference to the connected cylinder. This is determined and set for the cylinder used. The

[symbol]

The adjustment parameter determined results from the area ratio of the cylinder surfaces of the cylinder.

In a further advantageous embodiment, the first hydraulic cylinder surface and the second hydraulic cylinder surface are different. As a rule, differential cylinders are used that are designed with only one piston rod. This can, for example, lead to a shorter overall length, to a greater achievable force on the piston side and to a simplified sealing structure on the hydraulic cylinder. It is known that approx. 80% of the hydraulic cylinders used in practice are designed as differential cylinders.

In a further advantageous embodiment, the first hydraulic machine and/or the second hydraulic machine is selected from a group of pumps comprising at least one positive displacement pump. The hydraulic machine can, for example, be designed as an axial piston pump, radial piston pump or vane pump, gear pump, spindle pump and the like. It is also envisaged that the manually adjustable pump is a positive displacement pump,

[symbol]

[symbol] in particular an axial piston pump, radial piston pump or vane pump is trained.

The axial piston pump is used in hydraulics to convert mechanical energy into hydraulic energy. The volume flow can be adjusted using the axial piston pump.

In contrast to the radial piston pump, the working pistons of the radial piston pump are

[symbol]

Axial piston pump arranged radially and perpendicular to the drive shaft.

The radial piston pump is characterised by its high efficiency.

The vane pump is a positive displacement pump with a hollow cylinder in which another cylinder rotates. The delivery volume can be mechanically adjusted and/or set.

According to the invention, the second hydraulic machine is connected to the second hydraulic cylinder surface of the hydraulic cylinder. Preferably, the second hydraulic machine is connected to the second hydraulic cylinder surface of the hydraulic cylinder via a first connection. In an advantageous manner, the volumetric flow can be increased by means of this configuration to the volume of the first hydraulic machine of the hydraulic cylinder.

[symbol] drive system can be designed to be smaller. In this respect, the design of the

[symbol]

The first hydraulic machine is correspondingly smaller and therefore more cost-effective and less maintenance-intensive and/or prone to faults and malfunctions.

In a further advantageous embodiment, the first hydraulic machine is connected to the first hydraulic cylinder surface of the hydraulic cylinder. Preferably, the first hydraulic machine is connected to the first hydraulic cylinder surface of the hydraulic cylinder via a first connection. In this embodiment, the volume of the first hydraulic machine is smaller. Furthermore, the first hydraulic machine has two connections, one of which can be pressurised with the entire working pressure.

According to the invention, the first hydraulic machine is connected to a reservoir of the hydraulic drive system. Preferably, the first hydraulic machine is connected to a reservoir of the hydraulic drive system via a second connection.

In a further advantageous embodiment, the second hydraulic machine is hydraulically connected to the first hydraulic cylinder surface. Preferably, the second hydraulic machine is hydraulically connected to the first hydraulic cylinder surface via a second connection.

The reservoir is designed to store additional hydraulic fluid for the hydraulic system. drive system according to demand. A suction valve can be provided between the first hydraulic machine and the reservoir. Since the second hydraulic machine is intended to be connected to the first hydraulic cylinder side and the second hydraulic cylinder side, the second hydraulic machine conveys the hydraulic fluid between the two hydraulic cylinder sides, depending on the direction of rotation, from the first hydraulic cylinder side to the second hydraulic cylinder side.

[symbol] of the first hydraulic cylinder side to the second hydraulic cylinder side or from the second hydraulic cylinder side to the first hydraulic cylinder side.

In this embodiment, the first hydraulic machine can be provided to equalise only the volume ratio of the first hydraulic cylinder side and the second hydraulic cylinder side. The required delivery volume of the first hydraulic machine is therefore smaller compared to an embodiment in which the second hydraulic machine is not connected to the first hydraulic cylinder side. The first hydraulic machine can therefore be smaller, which reduces the space required for installation and assembly and thus the technical effort and costs incurred.

For example, the second hydraulic machine is hydraulically connected to a reservoir of the hydraulic drive system. Preferably, the second hydraulic machine is hydraulically connected to a reservoir of the hydraulic drive system via a second connection.

In this advantageous configuration, the second connection of the second hydraulic machine is preferably always connected to the reservoir. This means that a hydraulic machine can be provided with a pressure connection. This allows the internal structure of the hydraulic machine to be simplified. The first hydraulic machine, in contrast to the simplified second hydraulic machine, must provide the complete volume flow requirement of the first cylinder chamber and must be connected to the reservoir. [symbol] therefore be significantly larger.

The reservoir can be designed as a tank without overpressure. In a further advantageous embodiment, the reservoir can be pressurised.

In particular, the reservoir 6 can be designed as a pressurised reservoir. Preferably, the overpressure can be in a range of 2-25 bar, in particular preferably in a range of 2-10 bar. In this respect, increased suction of the first hydraulic machine and the second hydraulic machine is made possible.

Furthermore, this design advantageously means that the hydraulic medium (e.g. hydraulic fluid) can be separated from the atmosphere, thus counteracting ageing of the hydraulic medium.

In a further preferred embodiment, the pre-tensioned reservoir 6 is pressurised to a fluctuation range of preferably 22 bar, more preferably 14 bar. In an advantageous manner, the hydraulic pumps can be operated in this fluctuation range without reducing their sealing quality and/or quality. Furthermore, the hydraulic pumps can be operated in a range in which the load limits of the pump housing must be observed in order to prevent damage.

In a further advantageous embodiment, the first hydraulic machine and the second hydraulic machine have at least one high-pressure connection.

In a further advantageous embodiment, the first hydraulic machine or the second hydraulic machine has at least one high-pressure connection.

For example, a hydraulic connection of the first hydraulic machine and a hydraulic connection of the second hydraulic machine, which is connected to either the first hydraulic cylinder side or the second hydraulic cylinder side, can be designed as a high-pressure connection. In a further advantageous embodiment of the hydraulic drive system, the first hydraulic machine and/or the second hydraulic machine have a low-pressure connection. A hydraulic connection of the first hydraulic machine and a hydraulic connection of the second hydraulic machine, which is connected to the reservoir, can be designed as a low-pressure connection.

A high-pressure line can be connected via the high-pressure connection.

For example, a high-pressure line can be connected to the high-pressure connection to connect [symbol] be connected to the hydraulic cylinder. The low-pressure connection can be permanently connected to a tank line and provide a hydraulic connection to the reservoir.

In a further advantageous embodiment of the hydraulic drive system the first hydraulic machine and/or the second hydraulic machine have a high and low pressure accumulator. The first hydraulic machine is connected to the second hydraulic cylinder side of the hydraulic cylinder and the second hydraulic machine is connected to the first hydraulic cylinder side of the hydraulic cylinder. In a further advantageous embodiment of the hydraulic drive system, the first hydraulic machine is connected to the second hydraulic cylinder side of the hydraulic cylinder.

[symbol] hydromachine and/or the second hydromachine has a high and low low pressure accumulator. The first hydraulic motor is connected to the first hydraulic cylinder side of the hydraulic cylinder and the second hydraulic motor is connected to the second hydraulic cylinder side of the hydraulic cylinder.

According to a further aspect, the present invention relates to a method of

[symbol]

Adjustment of a delivery volume of a hydraulic drive system with the features of the independent patent claim 10. Advantageous further embodiments of the method result from the subclaims relating to the method.

In an advantageous embodiment of the method, this comprises the further step:
Testing the first hydraulic machine and/or the second hydraulic machine on a test stand and/or by means of a test run to determine whether the adjusted delivery volume corresponds to the area ratio of the hydraulic cylinder.

In an advantageous way, the adjusted delivery volume can be checked by testing the hydraulic machine to determine whether it fulfils the requirements for the hydraulic drive system.

In a further advantageous embodiment of the method, the conveying volume is adjusted by setting an adjustment element with the determined first adjustment parameter. Preferably, the adjustment element is fixed via a counter element.

In an advantageous manner, the delivery volume of one of the hydraulic machines can be efficiently adjusted and thus changed via the adjusting element. Furthermore, with the present invention, the delivery volume only has to be changed/adjusted once via the adjustment element and can be adjusted again by the adjustment element. This setting can be fixed by using a counter element.

According to a preferred embodiment, the adjusting element is designed at least as a threaded spindle, as a threaded bolt or as a threaded screw. The adjusting element can be designed as a corresponding contour nut.

According to a further aspect, the present invention relates to a hydraulic [symbol] Drive system for controlling a hydraulic cylinder with a constant total pressure in the hydraulic drive system.

The above embodiments and further developments can be combined with each other as desired, if appropriate. In particular, the features of the method claims can be realised as structural features in the hydraulic drive system.

In addition, provision may be made to concretise the method by means of structural features. Other possible embodiments, further developments and implementations of the invention also include combinations of features of the invention described above or below with regard to the embodiments. In particular, the skilled person will also recognise individual aspects as

[symbol]

Improvement or addition to the respective basic form of the present invention add.

The invention is explained below with reference to various embodiments, it being pointed out that these examples may be used to describe modifications or additions which are immediately apparent to the person skilled in the art with are included. Furthermore, these preferred embodiments do not constitute a limitation of the invention in such a way that variations and additions are within the scope of the present invention.

In the figures in the drawing, identical elements, features and components with the same function and the same effect are—unless otherwise stated—each referred to as are labelled with the same reference signs.

Showing:

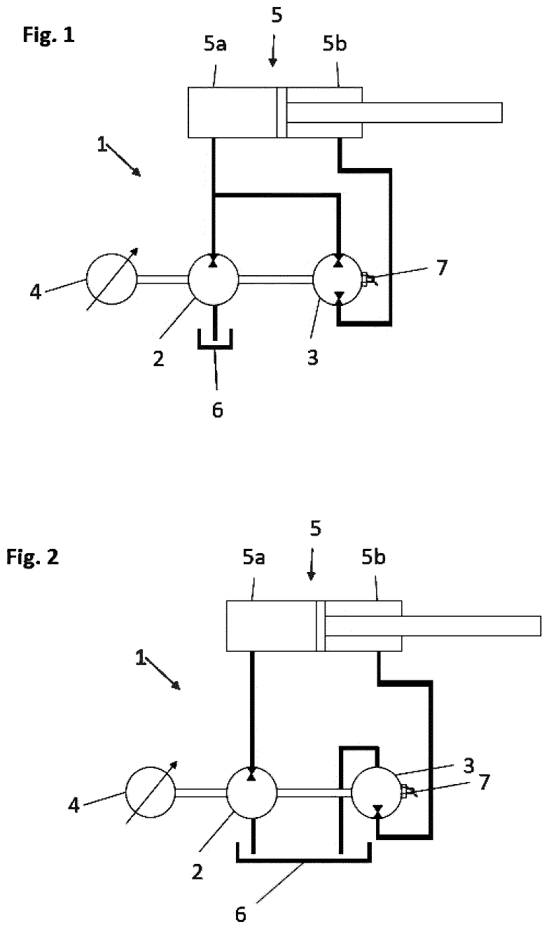

FIG. 1 a first embodiment of the hydraulic drive system according to the present invention;

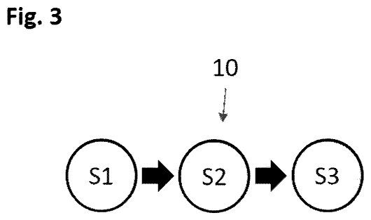

FIG. 2 an exemplary embodiment of the hydraulic drive system according to of the present invention, and

FIG. 3 a flow chart of an embodiment of a method according to the present invention.

FIG. 1 shows a hydraulic drive system 1. The hydraulic drive system 1 comprises a first hydraulic machine 2 and a second hydraulic machine 3.

Hydraulic machine 2 and the second hydraulic machine 3 are driven jointly via a shaft by a variable-speed drive 4. According to the invention, the first hydraulic machine 2 and the second hydraulic machine are mechanically connected to each other. The mechanical connection can be made via a shaft. The first hydraulic machine 2 and the second hydraulic machine 3 are designed as fixed displacement pumps. The first Hydraulic machine 2 is hydraulically connected to a reservoir 6. An after-suction valve (not shown) can be connected between the first hydraulic machine 2 and the reservoir 6. A reservoir 6 (expansion tank) is a container that holds the hydraulic oil or the hydraulic medium of the hydraulic drive system 1. The hydraulic fluid or the hydraulic medium can be a special mineral oil. The reservoir 6 is intended to store the hydraulic fluid, but otherwise keeps it unpressurised. The reservoir is to be understood as a tank without overpressure. This allows the reservoir 6 to be filled and emptied safely. The reservoir 6 is designed as a closed container that is connected to the surrounding air via vent valves.

[symbol] is. This connection is necessary so that pressure equalisation can take place.

Returning hydraulic fluid or the hydraulic medium would otherwise generate excess pressure and outflowing hydraulic fluid would generate negative pressure. The closed system ensures that no cavitation occurs and therefore the quality of the hydraulic medium (e.g. oil) is maintained or this does not age and/or ages less quickly. This means that premature replacement and/or maintenance intervals are reduced.

In a further preferred embodiment, the reservoir 6 can be pressurised. In particular, the reservoir 6 can be designed as a pressurised reservoir.

Preferably, an overpressure in a range of 2-25 bar, particularly preferably can be provided in a range of 2-10 bar. A reservoir with overpressure enables increased suction by the first hydraulic motor and the second hydraulic motor. Furthermore, this structure can separate the hydraulic medium from the atmosphere and thus counteract ageing of the hydraulic medium.

In a further preferred embodiment, the pre-tensioned reservoir 6 is pressurised to a fluctuation range of preferably 22 bar, more preferably 14 bar. In an advantageous manner, the hydraulic pumps can be operated in this fluctuation range without reducing their sealing quality and/or quality. Furthermore, the hydraulic pumps can be operated in a range in which the load limits of the pump housing are complied with in order to prevent to prevent damage.

The first hydraulic machine 2 and the second hydraulic machine 3 are hydraulically connected to a first hydraulic cylinder side 5a of a hydraulic cylinder 5. The second hydraulic machine 3 is hydraulically connected to the second hydraulic cylinder side 5b of the hydraulic cylinder 5.

[symbol] hydraulically connected.

When the variable-speed drive 4 drives the first hydraulic machine 2 and the second hydraulic machine 3, then, depending on the direction of rotation of the variable-speed drive 4, the first hydraulic machine 2 delivers hydraulic fluid from the reservoir 6 into the first hydraulic cylinder side 5a of the hydraulic cylinder and the second hydraulic machine 3 delivers hydraulic fluid from the reservoir 6 into the second hydraulic cylinder side 5a of the hydraulic cylinder.

Hydraulic machine 3 delivers hydraulic fluid from the second hydraulic cylinder side 5b of hydraulic cylinder 5 into the first hydraulic cylinder side 5a of hydraulic cylinder 5. The piston of hydraulic cylinder 5 is extended. If the drive 4 drives the first hydraulic machine 2 and the second hydraulic machine 3 in the other direction, the first hydraulic machine 2 delivers hydraulic fluid from the first hydraulic cylinder side 5a of the hydraulic cylinder 5 into the first hydraulic cylinder side 5b of the hydraulic cylinder 5.

[symbol] hydraulic cylinder 5 into the reservoir 6 and the second hydraulic machine 3 delivers hydraulic fluid from the first hydraulic cylinder side 5a of the hydraulic cylinder into the second hydraulic cylinder side 5b of hydraulic cylinder 5. The piston of hydraulic cylinder 5 is retracted.

The delivery volume in the hydraulic drive system 1 can be controlled via the speed of the variable-speed drive 4. The first hydraulic machine 2 must be [symbol] of this arrangement merely equalise the volume ratio of the first hydraulic cylinder side 5a and the second hydraulic cylinder side 5b. The delivery volume of the first hydraulic machine 2 can therefore be smaller than in other arrangements. The design of the first hydraulic machine 2 can therefore be smaller.

It is envisaged that the delivery volume of at least one hydraulic machine 2, 3 per pump revolution or to adjust and fix it mechanically. For this purpose, the fixed delivery volume of the first hydraulic motor 2 and/or the second hydraulic motor 3 is changed. In the case of a radial piston pump (RKP), for example, the delivery volume can be adjusted via the eccentricity of the stroke ring. This leads to an adjustment of the stroke of the pistons or vanes and therefore to a

[symbol]

Change in delivery volume per pump revolution. Via a corresponding

[symbol]

The eccentricity of the lifting ring can be adjusted using the spindle provided and the delivery volume per pump revolution can be adjusted and fixed. The stroke adjustment can be locked using a mechanical locking device. In the case of stroke adjustment via an adjusting spindle, the locking can be done via a lock nut. In

[symbol]

[symbol] advantageously, the inventive structure and the use of exclusively fixed displacement pumps (for example external gear pumps, internal gear pumps, screw pumps) or variable displacement pumps (for example axial piston pumps, radial piston pumps, vane pumps) for the first hydraulic machine 2 and the second hydraulic machine 3 is essentially simpler.

[symbol] and more reliable in operation compared to variable displacement pumps, whose delivery volume can be permanently adjusted during operation. The disadvantage of variable displacement pumps is that a considerable amount of additional work is required for the control system. With variable displacement pumps, the adjustment is realised via so-called control pistons, which are actuated with a corresponding pressure or a hydraulic fluid, which requires an additional proportional valve in order to [symbol] regulates the pressure in the spool. A travel measuring system is also provided to record the position. Furthermore, a control system is required to supply the proportional valve. This represents a considerable additional expense. In this respect, the present invention is easier to realise in its design and is also more reliable due to the smaller number of components to be supplied.

Furthermore, it is advantageous that the control of the hydraulic drive system more efficient and simple, as the delivery volume only needs to be set or adjusted once. The delivery volume of the second hydraulic machine 3 can be matched to the hydraulic cylinder/area ratio by adjusting the extra force of the lifting ring. The conveyed volume flow in the hydraulic drive system 1 can be adjusted via the speed of the first and second hydraulic cylinders.

Hydraulic machine 2, 3.

Preferably, at least one of the hydraulic machines 2, 3 is designed as an axial piston pump, radial piston pump or vane pump and has a manual mechanical stroke adjustment of the delivery volume. The other hydraulic machine 2, 3 can be designed as a fixed displacement pump or as an adjustable fixed displacement pump.

[symbol] be trained.

In the embodiment shown in FIG. 1, the volume of the first hydraulic machine 2 can be smaller than in comparison to the first hydraulic machine 2 used in the exemplary embodiment shown in FIG. 2. This means that the first hydraulic machine 2 in FIG. 1 can be designed to be correspondingly smaller, and the volume of the first hydraulic machine 2 in FIG. 2 can be smaller.

[symbol] is reflected in a more cost-effective application. The second hydraulic machine shown in FIG. 1 has two connections, both of which can be pressurised to full working pressure.

In FIG. 1, the second hydraulic machine 3 has the adjustment 7. The adjustment 7 is designed to adjust the first hydraulic machine 2 and/or the second hydraulic machine 3 for the first hydraulic machine 2 and/or the second hydraulic machine 3.

[symbol] to adjust an adjustable delivery volume. In particular, the delivery volume can be mechanically adjusted via the adjustment 7. In FIGS. 1 and 2, the second hydraulic machine 3 has the adjustment 7. This is only an exemplary and not a limiting illustration. If necessary, the first hydraulic machine 2 can also have the adjustment 7. Adjustment 7 can be used, for example, to

[symbol]

Piston pumps and vane pumps by adjusting the adjustment 7 of the

[symbol]

The stroke of the pistons or vanes can be adjusted manually. This stroke adjustment leads to a change in the conveying volume per revolution. The adjustment 7 can be changed with regard to the adjustment in accordance with the determined first adjustment parameter by turning it in or out. The adjustment 7 can be locked by means of a mechanical fixing device. This mechanical fixing device can be designed as a lock nut screwed onto the adjustment 7.

FIG. 2 shows a hydraulic drive system 1 according to an exemplary embodiment. The hydraulic drive system 1 according to FIG. 2 comprises a first hydraulic machine 2 and a second hydraulic machine 3. The first hydraulic machine 2 and the second hydraulic machine 3 are operated together, for example as shown, is driven by a variable-speed drive 4 via a shaft. The first hydraulic machine 2 is hydraulically connected to a first hydraulic cylinder side 5a of a hydraulic cylinder 5. The second hydraulic machine 3 is hydraulically connected to a second hydraulic cylinder side 5b of a hydraulic cylinder 5. The first hydraulic machine 2 and the second hydraulic machine 3 are each hydraulically connected to a reservoir 6 [symbol] connected. A post-suction valve can be provided between the first hydraulic machine 2 and the reservoir 6 and between the second hydraulic machine 3 and the reservoir 6. In a further embodiment, the first hydraulic machine 2 and the second hydraulic machine 3 are jointly connected to the reservoir 6 via an after-suction valve.

If the variable-speed drive 4 drives the first hydraulic machine 2 and the second hydraulic machine 3, then, depending on the direction of rotation of the variable-speed drive 4, the first hydraulic machine 2 delivers hydraulic fluid from the reservoir 6 to the first hydraulic cylinder side 5a of the hydraulic cylinder 5 and the second hydraulic machine 3 delivers hydraulic fluid from the second hydraulic cylinder side 5a to the second hydraulic cylinder side 5a.

[symbol] 5b of the hydraulic cylinder 5 into the reservoir 6. The piston is moved to an end position for example, the piston of the hydraulic cylinder 5 is extended. If the drive 4 drives the first hydraulic machine 2 and the second hydraulic machine 3 in the direction other than that described above, the first hydraulic machine 2 delivers hydraulic fluid from the first hydraulic cylinder side 5a of the hydraulic cylinder 5 into the first hydraulic cylinder side 5a.

[symbol] reservoir 6 and the second hydraulic machine 3 delivers hydraulic fluid from the second Hydraulic cylinder side 5b of the hydraulic cylinder 5 into the reservoir 6. The piston of the hydraulic cylinder 5 is retracted. The delivery volume (volume) in the hydraulic drive system 1 is controlled by the adjustment parameter in accordance with the invention.

The interconnection of the first hydraulic machine 2 and the second hydraulic machine 3, as shown in FIGS. 1 and 2, results in the following when using a

[symbol]

This means that the first hydraulic machine 2 and the second hydraulic machine 3 have the same delivery volume and therefore at least one hydraulic machine can be designed smaller compared to the state of the art mentioned at the beginning, which leads to a smaller space requirement and lower economic expenditure. The can be adjusted by changing the speed of the primary drive.

[symbol] and thus the travelling speed of the hydraulic cylinder 5 can be changed. Furthermore, the second hydraulic machine 3 can be designed as a 4-quadrant stage. The 4-quadrant stage can be designed as a 4-quadrant stage. Quadrant operation with positive torque and positive direction of rotation, with positive torque and negative direction of rotation, with negative torque and positive direction of rotation and with negative torque and negative direction of rotation.

In the exemplary embodiment shown in FIG. 2, the volume of the [symbol] first hydraulic machine 2 is larger compared to the first hydraulic machine in FIG. 1. The second hydraulic machine 3 has two connections, whereby only one is pressurised with full working pressure.

In the setup shown in FIG. 2, the second connection of the second hydraulic machine 3 is preferably always in fluid connection with the reservoir 6. The

[symbol]

The second hydraulic motor 3 can therefore be designed with only one pressure connection. This simplifies the internal design of the second hydraulic motor 3. The first hydraulic motor 2, on the other hand, now provides the entire volume flow requirement of the first cylinder chamber and is therefore larger compared to the embodiment shown in FIG. 1.

The reservoir 6 can be designed as a tank without overpressure. The reservoir 6 can also be designed as a reservoir that is pressurised. Preferably, an overpressure is provided in a range of 2-25 bar, particularly preferably in a range of 2-25 bar. This enables improved suction of the first hydraulic motor 2 and second hydraulic motor 3 on one side and on the other.

On the other hand, such an appropriate design makes it possible to separate the hydraulic medium from the atmosphere and thus counteract the ageing of the hydraulic medium.

FIG. 3 shows a flow diagram of a process 10 for adjusting a delivery volume in a hydraulic drive system 1.

Drive system 1 has a first hydraulic machine 2 and a second hydraulic machine 3. The method shown in FIG. 3 can comprise the following method steps S1-S3. In a first step S1, an area ratio between a first hydraulic cylinder area 5a and a second hydraulic cylinder area 5b of a hydraulic cylinder 5 of the hydraulic drive system 1 is determined.

In a further

[symbol]

In step S2, a target delivery volume of the first hydraulic machine or the second hydraulic machine of the hydraulic drive system 1 is determined. In a further step S3, a first adjustment parameter of the first hydraulic machine 2 or the second hydraulic machine 3 is determined. Using the determined first adjustment parameter, the delivery volume of the first hydraulic machine 2 or the second hydraulic machine 3 is determined.

[symbol] second hydraulic machine 3 of the hydraulic drive system 1. It can be used in a

[symbol]

In a further embodiment, it may be provided that further adjustment parameters are determined in order to adjust the delivery volume. In particular, it is envisaged that the delivery volume of the hydraulic drive system 1 can be adjusted by adjusting the delivery volumes of the first hydraulic machine 2 and the second hydraulic machine 3.

[symbol] adjust.

Furthermore, it may be provided that the method comprises a further step. The further step comprises testing the first hydraulic machine 2 and/or the second hydraulic machine 3 on a test bench. Furthermore, the first hydraulic machine 2 and/or the second hydraulic machine 3 can be tested by means of a test run.

[symbol] can be provided. Testing can be used to determine whether the adjusted delivery volume corresponds to the area ratio of the hydraulic cylinder.

Furthermore, it may be provided that the delivery volume is adjusted by setting an adjustment element, preferably a threaded spindle, threaded bolt or threaded screw with the determined first adjustment parameter.

Preferably, the adjustment element is provided via a counter element, preferably a contour nut.

### LIST OF REFERENCE SYMBOLS

1 Hydraulic drive system
2 First hydraulic machine
3 second hydraulic machine
4 Variable speed drive
5 Hydraulic cylinder
5a First hydraulic cylinder surface
5b Second hydraulic cylinder surface
6 Reservoir
7 Adjustment
S1-S3 Process steps

1. A hydraulic drive system (1) having a first hydraulic machine (2) and a second hydraulic machine (3), which are mechanically connected to one another;
wherein the first hydraulic machine (2) and the second hydraulic machine (3) are operated conjointly by a variable-speed drive (4);
wherein the first hydraulic machine (2) and the second hydraulic machine (3) are hydraulically connected to at least a first hydraulic cylinder (5), comprising a first hydraulic cylinder surface (5a) and a second hydraulic cylinder surface (5b); and
wherein the first hydraulic machine (2) and/or the second hydraulic machine (3) have an adjustable delivery volume.

2. The hydraulic drive system (1) as claimed in claim 1, wherein a ratio of the delivery volumes of the first hydraulic machine (2) and the second hydraulic machine (3) is mechanically adjustable to a surface ratio of the first hydraulic cylinder surface (5a) and the second hydraulic cylinder surface (5b).

3. The hydraulic drive system (1) as claimed in one of the preceding claims, wherein a delivery volume of the hydraulic drive system (1) is controlled by a determined adjustment parameter.

4. The hydraulic drive system (1) as claimed in one of the preceding claims, wherein the first hydraulic cylinder surface (5a) and the second hydraulic cylinder surface (5b) are different.

5. The hydraulic drive system (1) as claimed in one of the preceding claims, wherein the first hydraulic machine (2) and/or the second hydraulic machine (3) are/is selected from a group of pumps comprising at least a positive displacement pump, in particular an axial piston pump, radial piston pump or vane pump, gear pump, spindle pump and the like, and wherein the manually adjustable pump is a positive displacement pump, in particular an axial piston pump, radial piston pump, or vane pump.

6. The hydraulic drive system (1) as claimed in one of the preceding claims, wherein the second hydraulic machine (2) is connected to the second hydraulic cylinder surface (5b) of the hydraulic cylinder (5).

7. The hydraulic drive system (1) as claimed in one of the preceding claims, wherein the first hydraulic machine (2) is connected to the first hydraulic cylinder surface (5a) of the hydraulic cylinder (5).

8. The hydraulic drive system (1) as claimed in one of the preceding claims, wherein the first hydraulic machine (2) is connected to a reservoir (6) of the hydraulic drive system (1).

9. The hydraulic drive system (1) as claimed in the directly preceding claim, wherein the reservoir (6) is configured as a pre-stressed reservoir (6).

10. The hydraulic drive system (1) as claimed in the directly preceding claim, wherein the pre-stressed reservoir (6) has a pressure in a fluctuation range preferably of 22 bar, more preferably of 14 bar.

11. The hydraulic drive system (1) as claimed in one of the preceding claims, wherein the second hydraulic machine (3) is hydraulically connected to the first hydraulic cylinder surface (5a).

12. The hydraulic drive system (1) as claimed in one of claims 1 to 10, wherein the second hydraulic machine (2) is hydraulically connected to a reservoir of the hydraulic drive system (1).

13. The hydraulic drive system (1) as claimed in one of claims 1 to 12, wherein the first hydraulic machine (2) and/or the second hydraulic machine (3) have/has at least one high-pressure port.

14. A method (10) for adjusting a delivery volume in a hydraulic drive system (1) having a first hydraulic machine (2) and/or a second hydraulic machine (3) as claimed in one of claims 1 to 13, comprising the following method steps:
determining (S1) a surface ratio between a first hydraulic cylinder surface (5a) and a second hydraulic cylinder surface (5b) of a hydraulic cylinder (5) of the hydraulic drive system (1);
determining (S2) a target delivery volume of the first hydraulic machine and/or the second hydraulic machine (3);
determining (S3) a first adjustment parameter of the first hydraulic machine (2) and/or the second hydraulic machine (3), and
adjusting the delivery volume of the first hydraulic machine (2) and/or the second hydraulic machine (3) of the hydraulic drive system (1) using the determined first adjustment parameter.

15. The method as claimed in the directly preceding method claim, the method comprising the further step:
testing (S4) the first hydraulic machine (2) and/or the second hydraulic machine (3) on a test bench and/or by way of a test run to determine whether the adjusted delivery volume corresponds to the surface ratio of the hydraulic cylinder (5).

16. The method as claimed in one of the preceding method claims, wherein the adjustment of the delivery volume is carried out by adjusting an adjustment element using the determined first adjustment parameter, and wherein the adjustment element is preferably fixed via a locking element.

17. The method as claimed in the directly preceding method claim, wherein the adjusting element comprises at least one threaded spindle as a threaded bolt or as a threaded screw.

18. The hydraulic drive system (1) as claimed in one of claims 1 to 13, for controlling a hydraulic cylinder (5) with a constant total pressure in the hydraulic drive system (1).
